(19) United States
(12) Patent Application Publication
(10) Pub. No.: US 2026/0312188 A1
(43) Pub. Date: Oct. 8, 2026

(54) POUCH-TYPE SECONDARY BATTERY AND PRESSING APPARATUS FOR FORMING THE SAME

(71) Applicant: Samsung SDI Co., Ltd., Yongin-si (KR)

(72) Inventors: Jungyeon Song, Yongin-si (KR); Chanyoon Jung, Yongin-si (KR); Jehyun Lee, Yongin-si (KR); Hojin Song, Yongin-si (KR)

(73) Assignee: Samsung SDI Co., Ltd., Yongin-si (KR)

(21) Appl. No.: 19/634,531

(22) Filed: Mar. 31, 2026

(30) Foreign Application Priority Data
Apr. 2, 2025 (KR) 10-2025-0042971

(51) Int. Cl. H01M 50/105

(52) U.S. Cl. CPC H01M 50/105

(57) ABSTRACT

Disclosed are a pouch-type secondary battery and a pressing apparatus for forming the pouch-type secondary battery. The pouch-type secondary battery includes: an electrode assembly; and a casing including a cell accommodating portion configured to accommodate the electrode assembly, and a sealing portion extending from the cell accommodating portion. The cell accommodating portion includes a first surface covering an upper surface of the electrode assembly, a second surface covering at least a portion of one side surface of the electrode assembly, and a chamfer surface formed at an edge connecting the first surface and the second surface. The sealing portion includes a bending portion extending from the second surface of the cell accommodating portion, the bending portion being folded such that one surface thereof faces the second surface of the cell accommodating portion, and bent toward the chamfer surface.

### CROSS-REFERENCE TO RELATED APPLICATION

This present application claims priority to and the benefit under 35 U.S.C. § 119 (a)-(d) of Korean Patent Application No. 10-2025-0042971, filed on Apr. 2, 2025, in the Korean Intellectual Property Office, the entire disclosure of which is incorporated herein by reference.

### FIELD

The present disclosure relates to a pouch-type secondary battery and a pressing apparatus for forming the pouch-type secondary battery.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, a terminal part connected to the electrode assembly, etc.

The herein information disclosed in this Background section is for enhancement of understanding of the background of the present disclosure, and therefore, it may contain information that does not constitute related (or prior) art.

### SUMMARY

A pouch-type secondary battery according to embodiments of the present disclosure may include: an electrode assembly; and a casing including a cell accommodating portion configured to accommodate the electrode assembly, and a sealing portion extending from the cell accommodating portion. The cell accommodate may include a first surface covering an upper surface of the electrode assembly, a second surface covering at least a portion of one side surface of the electrode assembly, and a chamfer surface formed at an edge connecting the first surface and the second surface. The sealing portion may include a bending portion extending from the second surface of the cell accommodating portion, the bending portion being folded such that one surface thereof faces the second surface of the cell accommodating portion, and is bent toward the chamfer surface.

A pressing apparatus for forming the pouch-type secondary battery according to embodiments of the present disclosure may include a pressing jig disposed to face the second surface of the cell accommodating portion and provided to be movable toward the second surface of the cell accommodating portion, the pressing jig pressing the sealing portion SO that the sealing portion is pressed into close contact with the second surface of the cell accommodating portion with an adhesive interposed therebetween. The pressing jig may include a pressing surface configured to bend the bending portion into close contact with the chamfer surface of the cell accommodating portion.

According to embodiments of the present disclosure, a folded sealing portion may be stably adhered and secured to an outer sheet having a chamfer surface by using a pressing jig having a pressing surface with a predetermined shape. Accordingly, the sealing portion may remain stably in close contact with the outer sheet having the chamfer surface in subsequent process environments or in actual use environments, thereby improving product reliability and process stability.

However, aspects and features of the present disclosure are not limited to those described herein, and other aspects and features not mentioned will be clearly understood by a person skilled in the art from the detailed description, described herein.

### BRIEF DESCRIPTION OF THE DRAWINGS

FIG. 1 is a perspective view illustrating an example of a structure of a pouch-type secondary battery.

FIG. 2 is a perspective view schematically illustrating a structure of the pouch-type secondary battery in which a side sealing portion is folded.

FIG. 3 is a cross-sectional view schematically illustrating a pressing apparatus for manufacturing a pouch-type secondary battery.

FIG. 4 is a view illustrating a shape of a casing formed by using the pressing apparatus for manufacturing the pouch-type secondary battery.

FIG. 5 is a cross-sectional view schematically illustrating a pressing apparatus for manufacturing a pouch-type secondary battery according to embodiments of the present disclosure. FIG. 6 is a view illustrating a shape of a casing formed by using the pressing apparatus for manufacturing the pouch-type secondary battery according to embodiments of the present disclosure.

FIG. 7 is a cross-sectional view schematically illustrating a pressing apparatus for manufacturing a pouch-type secondary battery according to embodiments of the present disclosure.

FIG. 8 is a cross-sectional view schematically illustrating a pressing apparatus for manufacturing a pouch-type secondary battery according to embodiments of the present disclosure.

### DETAILED DESCRIPTION

Exemplary embodiments of the present disclosure will be described herein in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own disclosure in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments. Reference to two compared elements, features, etc. as being “the same” means that they are “substantially the same” Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component. “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected” , “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, Or section from another element, component, region, layer, Or section. Accordingly, a first element, component, region, layer, or section discussed herein may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

A secondary battery casing may include a first outer sheet and a second outer sheet that accommodate an electrode assembly therein. For sealing of the casing, respective ends of the first outer sheet and corresponding ends of the second outer sheet may adhere to each other. Each of. the adhered ends may be referred to as a sealing portion. The sealing portion may be secured to an outer sheet in a folded state and may be provided to subsequent process environments or to actual use environments. The sealing portion needs to remain stably secured to the outer sheet in order to ensure process stability or product reliability. However, depending on the shape of the outer sheet to which the sealing portion is secured, a defect may occur in which the sealing portion is not reliably secured to the outer sheet or fails to maintain the secured state and is separated and spaced apart from the outer sheet, and therefore a solution capable of alleviating the defect is required.

Embodiments of the present disclosure are directed to providing a pouch-type secondary battery capable of stably securing a folded sealing portion to an outer sheet, and a pressing apparatus for forming the pouch-type secondary battery.

However, the technical problem to be solved by the present disclosure is not limited to the problems described herein, and other problems not mentioned herein, and aspects and features of the present disclosure that would address such problems, will be clearly understood by those skilled in the art from the description of the present disclosure herein. Examples of secondary batteries include a coin type, a cylindrical type, a prismatic type, and a pouch type. The present disclosure is basically applicable to a pouch type secondary battery. Therefore, the pouch type secondary battery will first be briefly described prior to description of embodiments of the present disclosure.

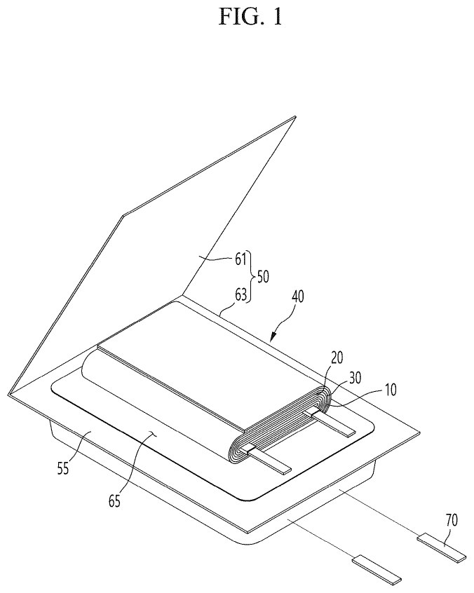

FIG. 1 is a perspective view illustrating an example of a structure of a pouch-type secondary battery.

Referring to FIG. 1, a pouch type secondary battery 1 may include an electrode assembly 40 in which a separator 30 has been interposed between a first electrode plate 10 and a second electrode plate 20 and a case 50 in which the electrode assembly 40 has been embedded. The first electrode plate 10, the second electrode plate 20, and the separator 30 may be impregnated in an electrolyte (not illustrated). the pouch type secondary battery 1 may include an electrode tab 70 that plays a role as an electrical passage for inducing a current formed in the electrode assembly 40 toward the outside, that is, a first electrode tab 71 and a second electrode tab 72.

The electrode assembly 40 may be formed by winding or stacking a stack body including the first electrode plate 10, the second electrode plate 20, and the separator 30 each of which is formed in a plate or film shape. In the case of the winding stack body, the winding axis of the electrode assembly 40 may be parallel to the length direction of the case. Furthermore, the electrode assembly 40 may be the stack type not the winding type, but a shape of the electrode assembly 40 is not limited in embodiments of the present disclosure. The first electrode plate 10 of the electrode assembly 40 may play a role as a positive electrode, and the second electrode plate 20 thereof may play a role as a negative electrode, and vice versa.

The first electrode plate 10 may be formed by applying a first electrode active material, such as graphite or carbon, to a first electrode collector plate formed of metal foil, such as copper, a copper alloy, nickel, or a nickel alloy, and may include a first electrode tab for a first uncoated part), that is, an area to which the first electrode active material has not been applied.

The second electrode plate 20 may be formed by applying a second electrode active material, such as transition metal oxide, to a material formed of metal foil, such as aluminum or an aluminum alloy, and may include a second electrode tab (or a second uncoated part), that is, an area to which the second electrode active material has not been applied.

The separator 30 may function to prevent a short-circuit between the first electrode plate 10 and the second electrode plate 20 while permitting a movement of lithium ions. The separator 30 may be composed of a polyethylene film, a polypropylene film, or a polyethylene-polypropylene film, for example.

The case 50 may be composed of a laminate film or a plastic, as a pouch type. The casing 50 may include a first outer sheet 61 and a second outer sheet 63. The first outer sheet 61 and the second outer sheet 63 may be connected to each other at one side, and may be sealed to each other with the electrode assembly 40 accommodated in an internal space defined therebetween. However, the disclosure is not limited thereto. At least one of the first outer sheet 61 or the second outer sheet 63 may include a recess 65 formed to have a predetermined depth to accommodate at least a portion of the electrode assembly 40. Hereinafter, for convenience of explanation, the case where the first outer sheet 61 is provided with the recess 65 to accommodate the electrode assembly 40 will be described by way of example.

The case 50 is sealed by the sealing portions at the edges contacting each other while accommodating the electrode assembly 40. In this case, the sealing is performed with the electrode tab 70, or the positive electrode tab 71 and the negative electrode tab 72 placed between the sealing portions. The sealing portion of the case 50 is made of a heat-melting material, and has a structure in which sealing is achieved by bonding heat-melting layers to each other. Prior to describing embodiments of the present disclosure, is apparent that terms referring to axes illustrated in the drawings, terms designating the axes, and terms indicating directions based on the axes such as an up and down direction (or a Z-axis direction), a forward and backward direction (or a Y-axis direction), and a left and right direction (or an X-axis direction) are provided only to present relative references for describing embodiments of the present disclosure, and are not intended to specify any direction or position in an absolute sense, and may vary relatively depending on a position of a target object, a position of an observer, or a view direction.

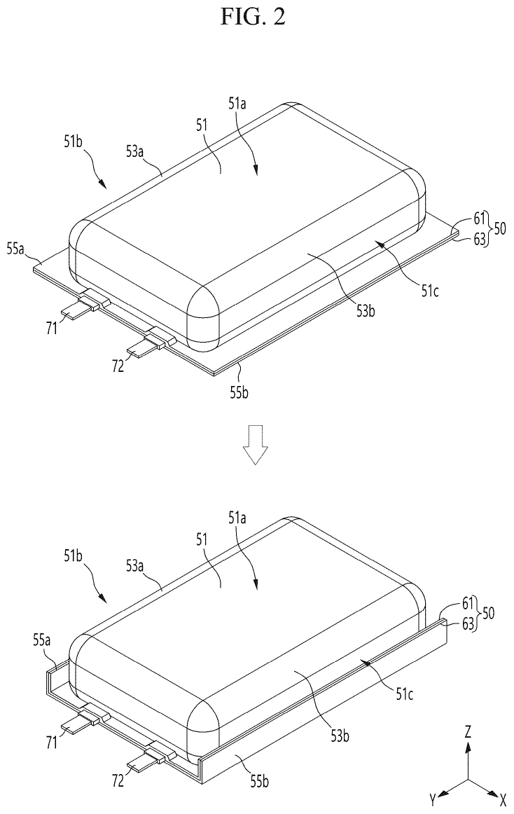

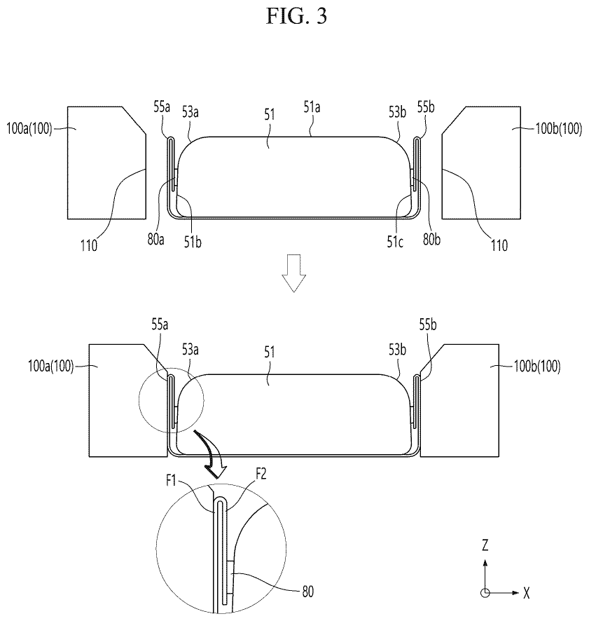

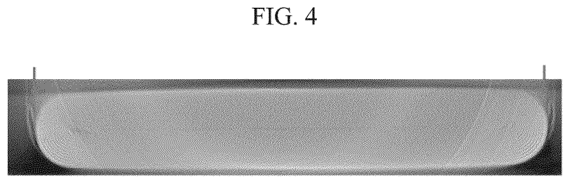

FIG. 2 is a perspective view schematically illustrating a structure of the pouch-type secondary battery in which a side sealing portion is folded. FIG. 3 is a cross-sectional view schematically illustrating a pressing apparatus for manufacturing a pouch-type secondary battery. FIG. 4 a view illustrating a shape of a casing formed by using the pressing apparatus for manufacturing the pouch-type secondary battery.

Referring to FIGS. 2 and 3, the pouch-type secondary battery according to the present disclosure may include a casing 50 that accommodates an electrode assembly 40 therein. The casing 50 may define an approximate external shape of the secondary battery. The casing 50 may include a cell accommodating portion 51 that accommodates at least a portion of the electrode assembly 40, and a sealing portion 5 extending from the cell accommodating portion 51.

The cell accommodating portion 51 may be a portion in which the electrode assembly 40 is accommodated and may have an external shape corresponding to a shape of the electrode assembly 40. For example, the cell accommodating portion 51 may include a first surface 51a that covers an upper surface of the electrode assembly 40, a second surface 51b that covers at least a portion of one side surface of the electrode assembly 40, a third surface 51c that covers at least a portion of a remaining side surface of the electrode assembly 40, a fourth surface that covers at least a portion of a front surface of the electrode assembly 40, a fifth surface that covers at least a portion of a rear surface of the electrode assembly 40, and a sixth surface that covers a lower surface of the electrode assembly 40. An edge connecting the first surface 51a and the second surface 51b of the cell accommodating portion 51, and an edge connecting the first surface 51a and the third surface 51c of the cell accommodating portion 51 may include chamfer surfaces 53a and 53b. As needed, an edge connecting the first surface 51a and the fourth surface of the cell accommodating portion 51, and an edge connecting the first surface 51a and the fifth surface of the cell accommodating portion 51 may include chamfer surfaces. In embodiments, the chamfer surfaces 53a and 53b may be rounded surfaces. The chamfer surfaces 53a and 53b may have a predetermined curvature. The chamfer surface formed at the edge connecting the first surface 51a and the second surface 51b of the cell accommodating portion 51 may be referred to as a first chamfer surface 53a. The chamfer surface formed at the edge connecting the first surface 51a and the third surface 51c of the cell accommodating portion 51 may be referred to as a second chamfer surface 53b.

The sealing portion 55 may be a portion extending from the cell accommodating portion 51 to seal the casing 50. The sealing portion 55 may include a first sealing portion 55a that extends from the second surface 51b of the cell accommodating portion 51 toward one side (for example, in a −X-axis direction), a second sealing portion 55b that extends from the third surface 51c of the cell accommodating portion 51 toward a remaining side (for example, in a +X-axis direction), and a third sealing portion that extends from the fourth surface of the cell accommodating portion 51 toward front direction (for example, in a +Y-axis direction). The third sealing portion may correspond to a region in which electrode tabs 71 and 72 of the electrode assembly 40 extend. That is, at least a portion of each of the electrode tabs 71 and 72 of the electrode assembly 40 may be exposed to the outside through the third sealing portion.

The first sealing portion 55a and the second sealing portion 55b may be referred to as side sealing portions. At least one of the first sealing portion 55a and the second sealing portion 55b may be folded. In the drawings, the case where both the first sealing portion 55a and the second sealing portion 55b are folded is illustrated by way of example, but the disclosure is not limited thereto.

The first sealing portion 55a may extend from the second surface 51b of the cell accommodating portion 51 and may be folded such that one surface the first sealing portion 55a faces the second surface 51b of the cell accommodating portion 51. As the first sealing portion 55a is folded, an end of the first sealing portion 55a may extend upward. The first sealing portion 55a may be folded a plurality of times. For example, the end of the first sealing portion 55a may be folded in an upward direction through a primary folding process (as designated by F1 in the drawing), and may be additionally folded downward in a reverse direction of the upward direction through a secondary folding process (as designated by F2 in the drawing). The secondary folding process F2 may be performed such that the end of the first sealing portion 55a is directed toward a space provided between the first sealing portion 55a and the second surface 51b of the cell accommodating portion 51. The folded first sealing portion 55a may be fixed to the second surface 51b of the cell accommodating portion 51 through a first adhesive layer 80a. The first adhesive layer 80a may be interposed between one surface of the first sealing portion 55a and the second surface 51b of the cell accommodating portion 51. The second sealing portion 55b may extend from the third surface 51c of the cell accommodating portion 51 and may be folded such that one surface of the second sealing portion 55b faces the third surface 51c of the cell accommodating portion 51. As the second sealing portion 55b is folded, an end of the second sealing portion 55b may extend upward. The second sealing portion 55b may be folded a plurality of times. For example, the end of the second sealing portion 55b may be folded in an upward direction through a primary folding process, and may be additionally folded downward in a reverse direction of the upward direction through a secondary folding process. The secondary folding process may be performed such that the end of the second sealing portion 55b is directed toward a space provided between the second sealing portion 55b and the third surface 51c of the cell accommodating portion 51. The folded second sealing portion 55b may be fixed to the third surface 51c of the cell accommodating portion 51 through a second adhesive layer 80b. The second adhesive layer 80b may be interposed between one surface of the second sealing portion 55b and the third surface 51c of the cell accommodating portion 51.

More specifically, the casing 50 may include a first outer sheet 61 and a second outer sheet 63. The first outer sheet 61 and the second outer sheet 63 may be connected to each other at one side and may be sealed to each other with the electrode assembly 40 accommodated in an internal space defined therebetween. At least one of the first outer sheet 61 and the second outer sheet 63 may include a recess 65 (see FIG. 1) formed to have a predetermined depth to accommodate at least a portion of the electrode assembly 40. The recess 65 (see FIG. 1) of the first outer sheet 61 may form at least a portion of the cell accommodating portion 51. Alternatively, the recess 65 (see FIG. 1) of the first outer sheet 61 may be referred to as the cell accommodating portion 51.

The casing 50 in which the electrode assembly 40 is accommodated therein may be sealed with edges of the casing 50 brought into contact with and adhered to each other. In other words, for sealing of the casing 50, respective ends of the first outer sheet 61 and corresponding ends of the second outer sheet 63 may adhere to each other, and each of the adhered ends may be referred to as the sealing portion 55. The first outer sheet 61 and the second outer sheet 63 may include a heat-fusion material, and heat-fusion layers may be adhered to each other through a heat-fusion process, thereby sealing the casing 50. The side sealing portions may be folded. That is, the ends of the first outer sheet 61 and the second outer sheet 63 constituting the side sealing portions may be folded upward.

Referring to FIG. 3, a pressing apparatus (hereinafter referred to as “pressing apparatus”) for manufacturing a pouch-type secondary battery according to embodiments of the present disclosure may be an apparatus configured to provide a predetermined pressure for stably adhering the folded sealing portion 55 to the cell accommodating portion 51. The pressing apparatus may include a pressing jig 100. The pressing jig 100 may include a first pressing jig 100a configured to fix the folded first sealing portion 55a to the second surface 51b of the cell accommodating portion 51, and a second pressing jig 100b configured to fix the folded second sealing portion 55b to the third surface 51c of the cell accommodating portion 51. The pressing jig 100 may be configured to be movable by receiving a driving force from at least one driving unit. Because known units may be employed as the driving unit, a detailed description thereof will be omitted.

An adhesion process using the pressing jig 100 may be performed as follows. The casing 50 including the cell accommodating portion 51 that accommodates the electrode assembly 40 therein and the sealing portion 55 extending from the cell accommodating portion 51 may be provided. A folding process of folding the first sealing portion 55a and the second sealing portion 55b may be performed. A filling process of filling a space between the first sealing portion 55a and a second surface 51b of the cell accommodating portion 51, and a space between the second sealing portion 55b and a third surface 51c of the cell accommodating portion 51 with molten adhesive may be performed. As necessary, a sequence of the folding process and the filling process may be changed.

After the folding process or the filling process, a pressing process may be performed. The pressing process may include an alignment step of aligning the pressing jig 100 and a pressing step of pressing the folded sealing portion 55 using the pressing jig 100. The alignment step may be the step of positioning the first pressing jig 100a on one side of the first sealing portion 55a and positioning the second pressing jig 100b on a remaining side of a second sealing portion 55b. The pressing step may include the step of pressing the first sealing portion 55a through the first pressing jig 100a so that the first sealing portion 55a is brought into close contact with the second surface 51b of the cell accommodating portion 51 with the adhesive interposed therebetween, and the step of pressing the second sealing portion 55b through the second pressing jig 100b so that the second sealing portion 55b is brought into close contact with a third surface 51c of the cell accommodating portion 51 with the adhesive interposed therebetween. The pressing step may be performed until the adhesive is cured to form an adhesive layer 80. The pressing step may further include a curing step of. curing the adhesive by providing heat of a predetermined temperature to the adhesive.

The pressing jig 100 may include a pressing surface 110 formed to press the sealing portion 55. The pressing surface 110 may have a flat surface, as illustrated. In this case, a pressing force required for contact and/or adhesion between the end of the sealing portion 55 and the chamfer surface 53 during the pressing process may not be ensured. Accordingly, as illustrated in FIG. 4, a phenomenon may occur in which the end of the sealing portion 55 is not adhered to the chamfer surface 53 of the cell accommodating portion 51, or is separated from the chamfer surface 53 rather than being maintained in the adhered state.

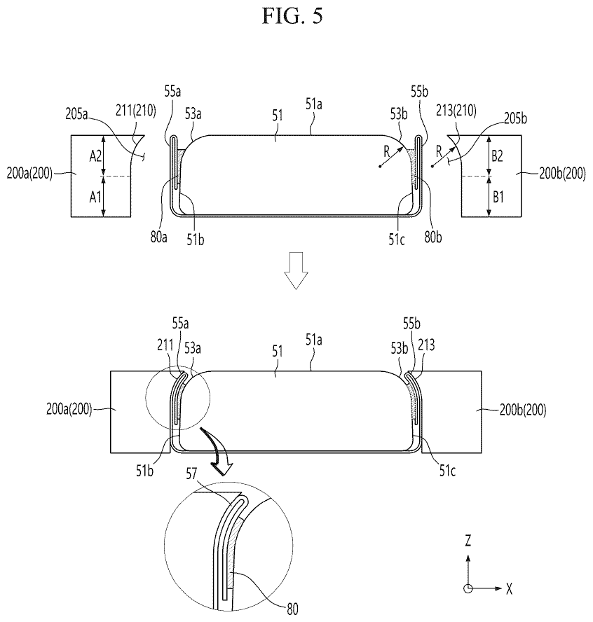

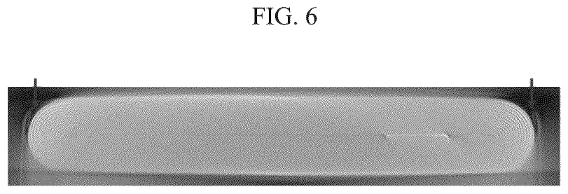

FIG. 5 is a cross-sectional view schematically illustrating a pressing apparatus for manufacturing a pouch-type secondary battery according to embodiments of the present disclosure. FIG. 6 is a view illustrating a shape of a casing formed by using the pressing apparatus for manufacturing the pouch-type secondary battery according to embodiments of the present disclosure.

Referring to FIG. 5, the pressing apparatus according to embodiments of the present disclosure may be an apparatus that provides a predetermined pressure to stably adhere the folded sealing portion 55 to the cell accommodating portion 51. The pressing apparatus may include a pressing jig 200. The pressing jig 200 may include a first pressing jig 200a configured to fix the folded first sealing portion 55a to the second surface 51b of the cell accommodating portion 51, and a second pressing jig 200b configured to fix the folded second sealing portion 55b to the third surface 51c of the cell accommodating portion 51.

The first pressing jig 200a may include a first pressing surface 211 that comes into contact with the first sealing portion 55a and presses the first sealing portion 55a. In response to a pressing operation of the first pressing jig 200a, an end of the folded first sealing portion 55a may abut against at least a portion of the first pressing surface 211 and then be bent, and may be brought into close contact with at least a portion of the first chamfer surface 53a of the cell accommodating portion 51. The first pressing jig 200a may include a first groove 205a that is open toward the folded first sealing portion 55a, the second surface 51b of the cell accommodating portion 51, and at least a portion of the first chamfer surface 53a of the cell accommodating portion 51, and is formed to accommodate the folded first sealing portion 55a, the second surface 51b, and the first chamfer surface 53a. During the pressing process, the first sealing portion 55a, the second surface 51b of the cell accommodating portion 51, and at least a portion of the first chamfer surface 53a of the cell accommodating portion 51 may be accommodated in the first groove 205a in correspondence with movement of the first pressing jig 200a. The end of the first sealing portion 55a may abut against at least a portion of an inner circumferential surface of the first groove 205a and be brought into close contact with at least a portion of the first chamfer surface 53a of the cell accommodating portion 51. The inner circumferential surface of the first groove 205a may be the first pressing surface 211.

The first pressing surface 211 may include a first-1 region A1 corresponding to the second surface 51b of the cell accommodating portion 51, and a first-2 region A2 extending from the first-1 region A1 and corresponding to the first chamfer surface 53a of the cell accommodating portion 51. The first-2 region A2 may be a region protruding toward the cell accommodating portion 51 relative to the first-1 region A1. The first-1 region A1 may press the first sealing portion 55a into close contact with the second surface 51b of the cell accommodating portion 51. The first-2 region A2 may protrude relative to the first-1 region A1 and may bend the end of the first sealing portion 55a toward the first chamfer surface 53a and press the end of the first sealing portion 55a into close contact with the first chamfer surface 53a. The first-2 region A2 may gradually protrude toward the cell accommodating portion 51 as the first-2 region A2 extends away from the first-1 region A1.

The first pressing surface 211 may have a shape corresponding to the second surface 51b and the first chamfer surface 53a of the cell accommodating portion 51. The first chamfer surface 53a may be a rounded surface. For example, the first pressing surface 211 may include a first flat region A1 facing the second surface 51b of the cell accommodating portion 51, and a first bending region A2 extending from the first flat region A1 and facing the first chamfer surface 53a of the cell accommodating portion 51. The first bending region A2 may press the end of the first sealing portion 55a so that the end of the first sealing portion 55a is bent toward the first chamfer surface 53a and is brought into close contact with the first chamfer surface 53a. A curvature of the first bending region A2 may correspond to a curvature of the rounded surface. The curvature of the first bending region A2 may be the same as the curvature of the rounded surface.

The end of the first sealing portion 55a may be bent toward the first chamfer surface 53a through the pressing process using the first pressing jig 200a, and may be fixed to the cell accommodating portion 51 through the first adhesive layer 80a interposed between the first sealing portion 55a and the second surface 51b of the cell accommodating portion 51. The bent end of the first sealing portion 55a may be referred to as a first bending portion 57. In embodiments, the first adhesive layer 80a may be formed to be interposed between the end of the first sealing portion 55a and the chamfer surface 53 of the cell accommodating portion 51. In one example, the first adhesive layer 80a may extend so as to be interposed between the first-1 region A1 (or the first flat region) and the second surface 51b of the cell accommodating portion 51, and between the first-2 region A2 (or the first bending region) and the first chamfer surface 53a of the cell accommodating portion 51. In another example, the first adhesive layer 80a may include a first-1 adhesive layer interposed between the first-1 region A1 (or the first flat region) and the second surface 51b of the cell accommodating portion 51, and a first-2 adhesive layer interposed between the first-2 region A2 for the first bending region) and the first chamfer surface 53a of the cell accommodating portion 51.

The second pressing jig 200b may include a second pressing surface 213 that comes into contact with the second sealing portion 55b and presses the second sealing portion 55b. In response to a pressing operation of the second pressing jig 200b, an end of the folded second sealing portion 55b may abut against at least a portion of the second pressing surface 213 and then be bent, and may be brought into close contact with at least a portion of a second chamfer surface 53b Of the cell accommodating portion 51. The second pressing jig 200b may include a second groove 205b that is open toward the folded second sealing portion 55b, the third surface 51c of the cell accommodating portion 51, and at least a portion of the second chamfer surface 53b of the cell accommodating portion 51, and that is formed to accommodate the folded second sealing portion 55b, the third surface 51c, and the second chamfer surface 53b. During the pressing process, the second sealing portion 55b, the third surface 51c of the cell accommodating portion 51, and at least a portion of the second chamfer surface 53b of the cell accommodating portion 51 may be accommodated in the second groove 205b in correspondence with movement of the second pressing jig 200b. The end of the second sealing portion 55b may abut against at least a portion of an inner circumferential surface of the second groove 205b and be brought into close contact with at least a portion of the second chamfer surface 53b of the cell accommodating portion 51. The inner circumferential surface of the second groove 205b may be the second pressing surface 213.

The second pressing surface 213 may include a second-1 region B1 corresponding to the third surface 51c of the cell accommodating portion 51, and a second-2 region B2 extending from the second-1 region B1 and corresponding to the second chamfer surface 53b of the cell accommodating portion 51. The second-2 region B2 may be a region protruding toward the cell accommodating portion 51 relative to the second-1 region B1. The second-1 region B1 may press the second sealing portion 55b into close contact with the third surface 51c of the cell accommodating portion 51. The second-2 region B2 may protrude relative to the second-1 region B1 and may bend the end of the second sealing portion 55b toward the second chamfer surface 53b and press the end of the second sealing portion 55b into close contact with the second chamfer surface 53b. The second-2 region B2 may gradually protrude toward the cell accommodating portion 51 as the second-2 region B2 extends away from the second-1 region B1.

The second pressing surface 213 may have a shape corresponding to the third surface 51c and the second chamfer surface 53b of the cell accommodating portion 51. The second chamfer surface 53b may be a rounded surface. For example, the second pressing surface 213 may include a second flat region B1 facing the third surface 51c of the cell accommodating portion 51, and a second bending region B2 extending from the second flat region B1 and facing the second chamfer surface 53b of the cell accommodating portion 51. The second bending region B2 may press an end of the second sealing portion 55b so that the end of the second sealing portion 55b is bent toward the second chamfer surface 53b and is brought into close contact with the second chamfer surface 53b. A curvature of the second bending region B2 may correspond to a curvature of the rounded surface. The curvature of the second bending region B2 may be the same as the curvature of the rounded surface.

The end of the second sealing portion 55b may be bent toward the second chamfer surface 53b through the pressing process using the second pressing jig 200b, and may be fixed to the cell accommodating portion 51 through the second adhesive layer 80b interposed between the second sealing portion 55b and the third surface 51c of the cell accommodating portion 51. The bent end of the second sealing portion 55b may be referred to as a second bending portion. In embodiments, the second adhesive layer 80b may be formed to be interposed between the end of the second sealing portion 55b and the second chamfer surface 53b of the cell accommodating portion 51. In one example, the second adhesive layer 80b may extend so as to be interposed between the second-1 region B1 (or the second flat region) and the third surface 51c of the cell accommodating portion 51, and between the second-2 region B2 (or the second bending region) and the second chamfer surface 53b of the cell accommodating portion 51. In another example, the second adhesive layer 80b may include a second-1 adhesive layer interposed between the second-1 region B1 (or the second flat region) and the third surface 51c of the cell accommodating portion 51, and a second-2 adhesive layer interposed between the second-2 region B2 (or the second bending region) and the second chamfer surface 53b of the cell accommodating portion 51.

The pressing jig 200 according to embodiments of the present disclosure may include a pressing surface 210 that presses the sealing portion 55. The pressing surface 210 having the herein-described shape may bend an end 57 of the sealing portion 55 toward the chamfer surface 53 during the adhesion process, and may stably maintain the bent end 57 of the sealing portion 55 in close contact with the chamfer surface 53. The pressing operation through the pressing surface 210 may be performed with the end 57 of the bent sealing portion 55 maintained in close contact with the chamfer surface 53, until the adhesive is cured to form the adhesive layer 80. The end 57 of the sealing portion 55 may be adhered to the chamfer surface 53 of the cell accommodating portion 51 through the cured adhesive layer 80 with the end 57 bent toward the chamfer surface 53.

In embodiments of the present disclosure, as illustrated in FIG. 6, because the end of the sealing portion 55 may remain stably adhered to the chamfer surface 53 of the cell accommodating portion 51 with the end of the sealing portion 55 bent toward the chamfer surface 53, a problem in which the end of the sealing portion 55 is detached from the cell accommodating portion 51 in subsequent process environments and use environments may be prevented. The foregoing may indicate that product reliability and stability of the pouch-type secondary battery may be remarkably improved.

An adhesion process using the pressing jig 200 according to embodiments of the present disclosure may be performed as follows. The casing 50 including the cell accommodating portion 51 that accommodates the electrode assembly 40 therein and the sealing portion 55 may be provided. A folding process of folding the first sealing portion 55a and the second sealing portion 55b may be performed. A filling process of filling a space between the first sealing portion 55a and the second surface 51b of the cell accommodating portion 51, and a space between the second sealing portion 55b and the third surface 51c of the cell accommodating portion 51 with molten adhesive may be performed. As necessary, a sequence of the folding process and the filling process may be changed.

After the folding process, a pressing process may be performed. The pressing process may include an alignment step of aligning the pressing jig 200, and a pressing step of pressing the side sealing portions 55 using the pressing jig 200. The alignment step may be the step of positioning the first pressing jig 200a on one side of the first sealing portion 55a and positioning the second pressing jig 200b on a remaining side of the second sealing portion 55b. The pressing step may be the step of pressing the first sealing portion 55a through the first pressing jig 200a so that the first sealing portion 55a is brought into close contact with the second surface 51b and the first chamfer surface 53a of the cell accommodating portion 51 with the adhesive interposed therebetween, and pressing the second sealing portion 55b through the second pressing jig 200b so that the second sealing portion 55b is brought into close contact with the third surface 51c and the second chamfer surface 53b of the cell accommodating portion 51 with the adhesive interposed therebetween. In the pressing step, the end of the first sealing portion 55a may be bent toward the first chamfer surface 53a and brought into close contact with the first chamfer surface 53a. The end of the second sealing portion 55b may be bent toward the second chamfer surface 53b and brought into close contact with the second chamfer surface 53b. The pressing step may be performed until the adhesive is cured to form the adhesive layer 80. The pressing step may further include a curing step of curing the adhesive by providing heat of a predetermined temperature to the adhesive.

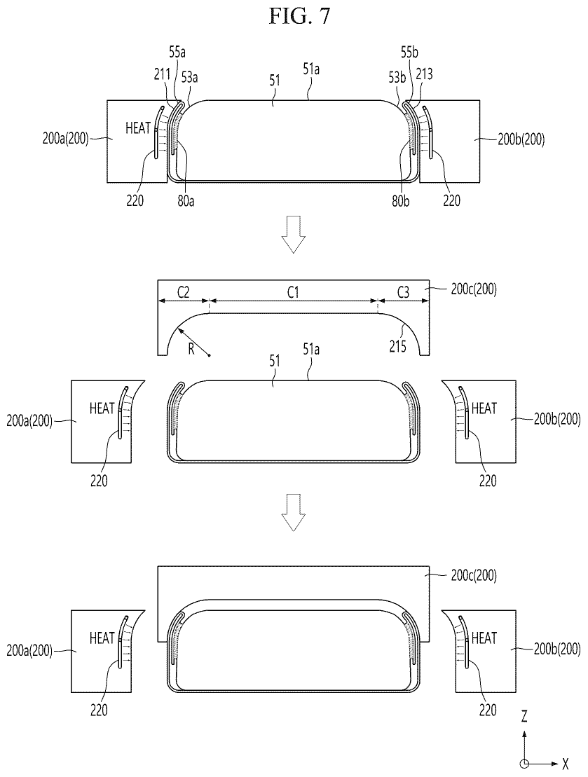

FIG. 7 is a cross-sectional view schematically illustrating a pressing apparatus for manufacturing a pouch-type secondary battery according to embodiments of the present disclosure. In describing embodiments of the present disclosure, descriptions of configurations substantially the same as those of the aforementioned embodiments will be omitted.

Referring to FIG. 7, the pressing apparatus according to embodiments of the present disclosure may be an apparatus that provides a predetermined pressure to stably adhere the folded sealing portion 55 to the cell accommodating portion 51. The pressing apparatus may include a pressing jig 200. The pressing jig 200 may include a first pressing jig 200a, a second pressing jig 200b, and a third pressing jig 200c. The third pressing jig 200c may be referred to as an auxiliary pressing jig 200.

The first pressing jig 200a may be disposed to face the second surface 51b of the cell accommodating portion 51 and may be provided to reciprocate in a left and right direction. The first pressing jig 200a may perform a function of pressing the folded first sealing portion 55a into close contact with the second surface 51b of the cell accommodating portion 51. The first pressing jig 200a may bend the end of the first sealing portion 55a into close contact with the first chamfer surface 53a of the cell accommodating portion 51. The second pressing jig 200b may be disposed to face the third surface 51c of the cell accommodating portion 51 and may be provided to reciprocate in the left and right direction. The second pressing jig 200b may perform a function of pressing the folded second sealing portion 55b into close contact with the third surface 51c of the cell accommodating portion 51. The second pressing jig 200b may bend the end of the second sealing portion 55b into close contact with the second chamfer surface 53b of the cell accommodating portion 51.

The third pressing jig 200c may be disposed to face the first surface 51a of the cell accommodating portion 51 and may be provided to reciprocate in an up and down direction. The third pressing jig 200c may perform a function of additionally pressing the end of the first sealing portion 55a brought into close contact with the first chamfer surface 53a, and the end of the second sealing portion 55b brought into close contact with the second chamfer surface 53b, with the pressing operations of the first pressing jig 200a and the second pressing jig 200b released. The third pressing jig 200c may include a third pressing surface 215 that presses the end of the first sealing portion 55a brought into close contact with the first chamfer surface 53a, and the end of the second sealing portion 55b brought into close contact with the second chamfer surface 53b. The third pressing surface 215 may be referred to as an auxiliary pressing surface.

The third pressing surface 215 may include a third-1 region C1 corresponding to the first surface 51a of the cell accommodating portion 51, a third-2 region C2 extending from one end of the third-1 region C1 and corresponding to the first chamfer surface 53a of the cell accommodating portion 51, and a third-3 region C3 extending from a remaining end of the third-1 region C1 and corresponding to the second chamfer surface 53b of the cell accommodating portion 51. The third-2 region C2 and the third-3 region C3 may be regions protruding toward the cell accommodating portion 51 relative to the third-1 region C1. The third-2 region C2 may protrude relative to the third-1 region C1 so as to additionally press the end of the first sealing portion 55a into close contact with the first chamfer surface 53a. The third-3 region C3 may protrude relative to the third-1 region C1 so as to additionally press the end of the second sealing portion 55b into close contact with the second chamfer surface 53b. The third-2 region C2 may gradually protrude toward the cell accommodating portion 51 as the third-2 region C2 becomes farther from the third-1 region C1. The third-3 region C3 may gradually protrude toward the cell accommodating portion 51 as the third-3 region C3 becomes farther from the third-1 region C1.

The third pressing surface 215 may have a shape corresponding to the first surface 51a, the first chamfer surface 53a, and the second chamfer surface 53b of the cell accommodating portion 51. The first chamfer surface 53a and the second chamfer surface 53b may be rounded surfaces. For example, the third pressing surface 215 may include a third flat region C1 facing the first surface 51a of the cell accommodating portion 51, a third-1 bending region C2 extending from one end of the third flat region C1 and facing the first chamfer surface 53a of the cell accommodating portion 51, and a third-2 bending region C3 extending from a remaining end of the third flat region Cl and facing the second chamfer surface 53b of the cell accommodating portion 51. The third-1 bending region C2 may additionally press the end of the first sealing portion 55a into close contact with the first chamfer surface 53a. The third-2 bending region C3 may additionally press the end of the second sealing portion 55b into close contact with the second chamfer surface 53b. A curvature of each of the third-1 bending region C2 and the third-2 bending region C3 may correspond to a curvature the corresponding rounded surface. In embodiments of the present disclosure, because the ends of the sealing portion 55 are additionally pressed through the third pressing jig 200c, the adhesion state between the ends of the sealing portion 55 and the chamfer surfaces 53 may be more stably maintained.

The pressing jig 200 may further include a heating wire 220 that provides heat for curing an adhesive. That is, at least one of the first pressing jig 200a, the second pressing jig 200b, or the third pressing jig 200c may include the heating wire 220 that provides heat. As described herein, during an adhesion process (for example, a curing step), the pressing jig 200 may press the sealing portion 55 into close contact with the cell accommodating portion 51 with the adhesive interposed therebetween. During the adhesion process, the heating wire 220 may be driven to transfer heat to the adhesive. The heating wire 220 may be driven in conjunction with movement of the pressing jig 200.

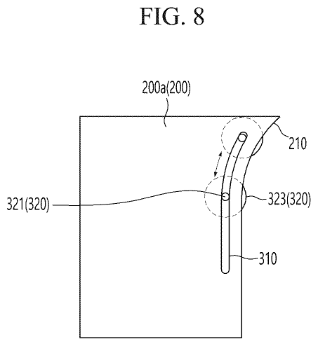

FIG. 8 is a cross-sectional view schematically illustrating a pressing apparatus for manufacturing a pouch-type secondary battery according to embodiments of the present disclosure. In describing £ embodiments of the present disclosure, descriptions of configurations substantially the same as those of the aforementioned embodiments will be omitted.

Referring to FIG. 8, the pressing apparatus according to embodiments of the present disclosure may be an apparatus that provides a predetermined pressure to stably adhere the folded sealing portion 55 to the cell accommodating portion 51. The pressing apparatus may include a pressing jig 200. The pressing jig 200 may be provided to reciprocate in the left and right direction, and may perform a function of pressing the folded sealing portion 55 into close contact with the cell accommodating portion 51. The pressing jig 200 may bend the end of the sealing portion 55 and bring the end of the sealing portion 55 into close contact with the chamfer surface 53 of the cell accommodating portion 51. The pressing jig 200 may include a pressing surface 210.

The pressing jig 200 may include a pressing roller unit 320 and a guide slot 310 that guides a path along which the pressing roller unit 320 moves. The guide slot 310 may be formed to pass through a thickness of the pressing jig 200 along a forward and backward direction, and may be formed to extend along a shape of the pressing surface 210. The guide slot 310 may be formed adjacent to the pressing surface 210. The pressing roller unit 320 may be movably engaged with the guide slot 310.

The pressing roller unit 320 may include a shaft 321 inserted into and movably provided in the guide slot 310, and a pressing roller 323 coupled to the shaft 321. The shaft 321 may be inserted into the guide slot 310 and may be movably provided along a trajectory of the guide slot 310. The pressing roller 323 may be coupled to the shaft 321, may be moved in response to movement of the shaft 321, and may be provided so as to be rotatable about the shaft 321. At least a portion of an outer circumferential surface of the pressing roller 323 may be exposed from the pressing jig 200 and may be provided to be contactable with the folded sealing portion 55. The pressing jig 200 may include a driving unit configured to provide a driving force for movement of the shaft 321. Because known units may be employed as the driving unit, a detailed description thereof will be omitted.

The pressing roller unit 320 may perform a function of additionally pressing the end of the sealing portion 55 that is in close contact with at least the chamfer surface 53 while the pressing jig 200 presses the sealing portion 55. In embodiments of the present disclosure, because the end of the sealing portion 55 is additionally pressed through the pressing roller unit 320, the adhesion state between the end of the sealing portion 55 and the chamfer surface 53 may be more stably maintained.

Hereinafter, materials which may be used in a secondary battery according to embodiments of the present disclosure are described.

A compound (e. g., a lithiated intercalation compound) capable of reversible intercalation and deintercalation of lithium may be used as positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them. For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂(0.90≤a≤1.8, 0.001≤b≤0.1); LiₐMn_{1-b}G_{b}O₂ (0.90≤a≤1.8, 0.001≤b≤0.1); LiₐMn₂G_{b}O₄(0.90≤a≤1.8, 0.001≤b≤0.1); LiₐMn_{1-g}F_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99 wt. % with respect to the positive electrode active material layer 100 wt. %. Content of the binder and the conductive material may be 0.5 wt. % to 5 wt. % with respect to the positive electrode active material layer 100 wt. %. A1 may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x≤2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99.5 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth) acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described herein in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A pouch-type secondary battery, comprising:
an electrode assembly; and
a casing including a cell accommodating portion configured to accommodate the electrode assembly, and a sealing portion extending from the cell accommodating portion,
wherein:
the cell accommodating portion comprises a first surface covering an upper surface of the electrode assembly, a second surface covering at least a portion of one side surface of the electrode assembly, and a chamfer surface formed at an edge connecting the first surface and the second surface, and
the sealing portion comprises a bending portion extending from the second surface of the cell accommodating portion, the bending portion being folded such that one surface thereof faces the second surface of the cell accommodating portion, and is bent toward the chamfer surface.

2. The pouch-type secondary battery as claimed in claim 1, further comprising an adhesive layer interposed between the sealing portion and the cell accommodating portion, and fixing the folded sealing portion to the cell accommodating portion.

3. The pouch-type secondary battery as claimed in claim 2, wherein the adhesive layer is interposed between the sealing portion and the second surface of the cell accommodating portion, and extends to a space between the bending portion and the chamfer surface of the cell accommodating portion.

4. The pouch-type secondary battery as claimed in claim 2, wherein the adhesive layer comprises a first adhesive layer interposed between the sealing portion and the second surface of the cell accommodating portion, and a second adhesive layer interposed between the bending portion and the chamfer surface of the cell accommodating portion.

5. The pouch-type secondary battery as claimed in claim 1, wherein the chamfer surface comprises a rounded surface having a predetermined curvature.

6. The pouch-type secondary battery as claimed in claim 5, wherein the bending portion is bent along the rounded surface.

7. The pouch-type secondary battery as claimed in claim 1, wherein the sealing portion is folded multiple times.

8. A pressing apparatus for forming the pouch-type secondary battery as claimed in claim 1, the pressing apparatus comprising
a pressing jig disposed to face the second surface of the cell accommodating portion and configured to be movable toward the second surface of the cell accommodating portion, the pressing jig pressing the sealing portion so that the sealing portion is pressed into close contact with the second surface of the cell accommodating portion with an adhesive interposed therebetween,
wherein the pressing jig comprises a pressing surface configured to bend the bending portion into close contact with the chamfer surface of the cell accommodating portion.

9. The pressing apparatus as claimed in claim 8,
wherein:
the pressing jig comprises a groove formed to accommodate the folded sealing portion, the second surface of the cell accommodating portion, and at least a portion of the chamfer surface of the cell accommodating portion,
the pressing surface comprises an inner circumferential surface of the groove.

10. The pressing apparatus as claimed in claim 8,
wherein:
the pressing surface comprises a first region corresponding to the second surface of the cell accommodating portion, and a second region extending from the first region and corresponding to the chamfer surface of the cell accommodating portion,
the second region protrudes toward the cell accommodating portion relative to the first region.

11. The pressing apparatus as claimed in claim 10, wherein the second region gradually protrudes toward the cell accommodating portion as the second region extends away from the first region.

12. The pressing apparatus as claimed in claim 10, wherein the second region presses and bends the bending portion.

13. The pressing apparatus as claimed in claim 8,
wherein:
the chamfer surface comprises a rounded surface having a predetermined curvature, and
the pressing surface has a shape corresponding to a shape of the second surface of the cell accommodating portion and the chamfer surface of the cell accommodating portion.

14. The pressing apparatus as claimed in claim 13, wherein the pressing surface comprises a flat region corresponding to the second surface of the cell accommodating portion and bringing the sealing portion into close contact with the second surface of the cell accommodating portion, and a bending region extending from the flat region, the bending region corresponding to the chamfer surface of the cell accommodating portion and bringing the bending portion into close contact with the chamfer surface of the cell accommodating portion.

15. The pressing apparatus as claimed in claim 14, wherein a curvature of the bending region corresponds to the curvature of the rounded surface.

16. The pressing apparatus as claimed in claim 8, further comprising an auxiliary pressing jig disposed to face the first surface of the cell accommodating portion and provided to be movable toward the first surface of the cell accommodating portion, the auxiliary pressing jig having an auxiliary pressing surface formed to additionally press the sealing portion and bring the sealing portion into close contact with the chamfer surface of the cell accommodating portion.

17. The pressing apparatus as claimed in claim 16, wherein the auxiliary pressing jig performs an additional pressing operation with a pressing operation of the pressing jig released.

18. The pressing apparatus as claimed in claim 16,
wherein:
the auxiliary pressing surface comprises a first region corresponding to the first surface of the cell accommodating portion, and a second region extending from the first region and corresponding to the chamfer surface of the cell accommodating portion, and
the second region of the auxiliary pressing surface protrudes toward the cell accommodating portion relative to the first region of the auxiliary pressing surface.

19. The pressing apparatus as claimed in claim 16,
wherein:
the auxiliary pressing surface comprises a first region corresponding to the first surface of the cell accommodating portion, and a second region extending from the first region and corresponding to the chamfer surface of the cell accommodating portion, and
the second region of the auxiliary pressing surface gradually protrudes toward the cell accommodating portion as the second region extends away from the first region of the auxiliary pressing surface.

20. The pressing apparatus as claimed in claim 8, wherein the pressing jig comprises a heating wire configured to provide heat to the adhesive.
